(19) United States
(12) Patent Application Publication
(10) Pub. No.: US 2010/0275857 A1
(43) Pub. Date: Nov. 4, 2010

(54) DEVICE FOR CLEANING A BOILER OF A COMBUSTOR, AND METHOD FOR THE OPERATION THEREOF

(75) Inventor: Friedrich Bude, Cottbus (DE)

Correspondence Address: BAINWOOD HUANG & ASSOCIATES LLC, 2 CONNECTOR ROAD, WESTBOROUGH, MA, 01581, US

(73) Assignee: CLYDE BERGEMANN GMBH, Wesel (DE)

(21) Appl. No.: 12/676,131

(22) PCT Filed: Sep. 2, 2008
(86) PCT No.: PCT/EP2008/061553

§ 371 Date: Jun. 18, 2010

(30) Foreign Application Priority Data
Sep. 4, 2007 (DE) 10 2007 042 051.1
Dec. 22, 2007 (DE) 10 2007 062 449.4

(51) Int. Cl. F28G 9/00; B08B 9/00

(52) U.S. Cl. 122/390; 134/166 R; 134/21

(57) ABSTRACT

A device (1) for cleaning a boiler (13) of a combustion system (16), comprising a fluid distributor (2) which has at least one flow passage (3) with an inlet opening (4) and an outlet opening (5), wherein the inlet opening (4) can be connected to a feed line (6) for a fluid, wherein the flow passage (3) is constructed with at least one connection changer (7) by which disconnecting of the at least one flow passage (3) from the feed line (7) and connecting of the at least one flow passage (3) to at least one further connecting unit (8) can be carried out. Furthermore, a method for operating such a device in connection with a boiler of a combustion system is proposed.

The present invention refers to a device for cleaning a boiler of a combustion system, including a fluid distributor which has at least one flow passage with an inlet opening and an outlet opening, wherein the inlet opening can be connected to a feed line for a fluid. Furthermore, a method for operating such a device for the periodic cleaning of a boiler of a combustion engine is disclosed here.

In connection with the operation of combustion systems it is of particular interest to achieve a high efficiency during energy conversion. For this, the hot flue gas is guided past a multiplicity of heat exchangers so that the heat is transferred to a heat exchange medium, especially water, which flows in the heat exchangers. During contact of the hot flue gas with these heat exchangers, however, contaminants, soot, and similar adherents, remain which in the medium term hinder the heat transfer of the flue gas to the heat exchange medium. Therefore, it is necessary to free the heat exchangers from these contaminants at predetermined intervals.

For cleaning these heat exchange surfaces or also the boiler wall (which possibly have heat exchanger tubes), for example cleaning devices are used, as are described in WO 96/38704. A cleaning device of the same generic type, which is constructed in a space-saving manner, results from EP 1 259 762 B1. This cleaning device, which in the case of the applicant is especially referred to as a water lance blaster, has a water lance by which a bundled water jet can be delivered through the boiler chamber onto an opposite wall or onto a heat exchanger, wherein as a result the contaminants which adhere there are removed. Such a cleaning can be carried out during the operation of the combustion system. For carrying out this cleaning process, the impingement area of the water jet is led along a predetermined path on the surface which is to be cleaned, also referred to as blast figure. The path in most cases (but not necessarily) is in meander form and so for example circumscribes, also in a directed manner, obstacles, openings or other sensitive zones in the cleaning area. On account of the genetic water jet energy and the sudden evaporation of water which has penetrated into the pores of the contaminants, a breaking away of the dirt consisting of soot, clinker and ash is brought about.

Even for checking the cleaning action of the cleaning device, the function or the operating state of the boiler and/or further functions, it may be necessary to also position sensors, alternative cleaning devices and the like on or in the boiler, in addition to cleaning devices. Building upon this idea, a corresponding device is described in DE 10 2006 005 012, wherein provision is made for means for detecting an environmental parameter through the outlet opening of the fluid distributor or of its flow passage. In this way, the advantage is achieved of the fluid distributor being able to be used not only as a cleaning device but supporting further functions.

Starting from this, it is the object of the present invention to develop the prior art, specifically especially in the way that an increased functionality or variability of such devices is achieved. Furthermore, an efficient cleaning and monitoring of the combustion system is to be ensured, wherein the maximum possible heat exchange area is only slightly restricted. Moreover, a method is to be disclosed in which monitoring of the operation of the boiler of the combustion system and/or maintenance of the cleaning device can be undertaken quickly and also during operation of the combustion system.

These objects are achieved in a device according to the features of patent claim 1 or in a method for operating such a device with the features of patent claim 7. Further advantageous developments of the invention are disclosed in the dependently formulated patent claims. Reference is to be made to the fact that the disclosed features in the dependently formulated patent claims can be combined with each other in any technologically meaningful way and can disclose further developments of the invention. The description, especially in conjunction with the figures, explains the invention further and discloses additional preferred example embodiments of the invention.

The device according to the invention for cleaning a boiler of a combustion system includes a fluid distributor which has at least one flow passage with an inlet opening and an outlet opening, wherein the inlet opening can be connected to a feed line for a fluid. The flow passage of the device is constructed with at least one connection changer by which disconnecting of the at least one flow passage from the feed line and connecting of the at least one flow passage to at least one further connecting unit can be carried out.

A “fluid distributor” particularly means a pipe-like construction which in its center includes a flow passage or if necessary even a multiplicity of flow to passages. The fluid distributor especially constitutes a so-called blast pipe for a cleaning device in the style of a water jet blaster. Via the feed line, a fluid (preferably water, but possibly also steam, air, etc. or mixtures of these fluids) is delivered to the fluid distributor. In this case, it is to be taken into consideration that the fluid distributor is regularly operated with relatively high speeds during operation so that a correspondingly loadable connection between feed line and fluid distributor is realized. The feed line is advantageously flexible and should be at least partially resistant to high temperature so that this is preferably formed by a flexible metal tube.

Furthermore, means for moving the fluid distributor (or movers) are basically provided. The means can include mechanical, magnetic, electromechanical, pneumatic or other drives, that is to say for example spindles, linear drives, etc., preferably in a cross arrangement or bridge arrangement for realizing a simple actuation in the Cartesian coordinate system. By “moving”, especially a pivoting of the blast pipe around a fixed point is meant, but it is also possible for a rotation and/or displacement of the fluid distributor to take place in this case. It is also possible in principle for a plurality of types of movement to at least partially overlap in the device during operation.

It is now further proposed here that the flow passage is constructed with at least one connection changer. By this is meant for example that the connection changer includes or forms a part of the flow passage. The connection changer now has the function of on the one hand connecting the feed line for the cleaning fluid to the at least one flow passage, especially at the time of the cleaning process, but at desired points of time also of breaking or isolating the connection and of making a connection to a further connecting unit. The connection changer in this case especially has the capacity to realize a relative movement between feed line, connecting unit, etc., on the one hand and the inlet opening of the flow passage of the fluid distributor on the other hand. In this case, the connection changer is a device which with corresponding drives enables the isolation or connection of the flow passage or of the fluid distributor to the feed line and to the further connecting units. In other words, this also means that by means of the connection changer the same inlet opening of the flow passage can now be brought into contact with, or connected to, the feed line on the one hand and at least one further connecting unit on the other hand. In this case, the at least one flow passage, at a specific point in time, is preferably connected in each case to only the feed line or to a further connecting unit, that is to say the connection changer decides which alternative connecting possibility or function is realized in this case.

According to a preferred development of the device, the at least one connection changer includes a plurality of connecting units. This can mean that the connection changer itself is constructed with functional units which are integrated into the connection changer, or positioned upon this, wherein small units in particular lend themselves for this. It is also possible, however, that only one connection to a plurality of possibly further-away connecting units (cable, hose, etc.) is connected to the connection changer. As a result, the connection changer constitutes a type of multifunctional connecting point which connects at least one flow passage and its fluid distributor to various connecting units.

In this connection, it is also further proposed that the at least one connection changer includes a rotary disk which has connections distributed over the circumference which can be connected to the inlet opening. If need be, it is also possible for the connection changer to include a plurality of rotary disks which are concentrically mounted. The rotary disk, which is especially positioned eccentrically to the fluid distributor, in this case is constructed with a circumferential region which brushes over the inlet opening during a rotation of the rotary disk. By means of a corresponding positioning of connections over the circumference and a specifically predeterminable angle of rotation of the rotary disk, the desired connection can be positioned in front of the inlet opening of the fluid distributor. The connections in this case are preferably designed so that in particular these are leakproof for a fluid even under operating conditions of the device, that is to say especially liquid-tight and/or even gastight.

Furthermore, it is proposed that the at least one connecting unit includes at least one of the following group: solid-matter accelerator, radiation sensor, laser emitter, optical detection system, cleaning unit, sealing unit, cooling unit, suction device. A solid-matter accelerator especially serves for moving solid bodies (balls, particles, ice, etc.) with, or possibly without, a carrier medium through a flow passage so that when this solid body impinges upon the boiler wall or upon the heat exchanger a corresponding cleaning can be achieved. In the case of a radiation sensor, radiations (visible or invisible light, sound, etc.) can especially be sent into the boilers of the combustion system and/or received again. A laser emitter, that is to say a source for a laser light, serves especially for calibrating the orientation of the fluid distributor or of the flow passage, wherein the laser initiates a reference point before or after the cleaning. Furthermore, it is also possible for the connection changer to connect the fluid distributor to an optical detection system, that is to say for example a telescope, a camera or comparable instruments which enable visual checking of the boiler interior or of the contamination. Also, a cleaning unit, especially for mechanical and/or pneumatic cleaning of the flow passage itself can be connected to the fluid distributor via the connection changer. Even in the case of a fluid distributor which has a plurality of flow passages, it may be sensible to provide a sealing unit for the sealing of at least one flow passage on the connection changer. In addition, cooling units can adjust the temperature of the fluid distributor or of the wall of the flow passage so that the function of the fluid distributor or of another connecting unit is ensured. In case for example specimens are to be taken from the interior of the boiler in the combustion system, provision can also be made for a suction device as a connecting unit, which consequently carries away particles and/or gases from the interior of the boiler.

As a development of the invention, it is also proposed that provision is made for a plurality of flow passages and for the at least one connection changer to be connectable to a plurality of flow passages at the same time. In this case, the connection changer can preferably connect the flow passage independently, that is to say especially freely selectably, to different and/or similar connecting units.

Similarly, the invention also relates to a boiler of a combustion system with at least one device of the type described here according to the invention, wherein the fluid distributor is movably arranged in a boiler wall so that the outlet opening is located inside the boiler and the at least one connection changer is located outside the boiler. For this purpose, the fluid distributor is especially arranged on the outside on the boiler wall in a frame fragment around a hatch of the boiler wall. This frame fragment for example accommodates the movement means for the fluid distributor. These movement means are now connected to a section of the fluid distributor which is provided outside the boiler, especially between the connection changer and the boiler wall. The front end of the fluid distributor, especially the nozzle, is arranged in or on a corresponding holder or hatch or joint of the boiler wall. In this case, penetrating of the fluid distributor, if only to a small extent, of the flow passage is periodically realized. Naturally, flow passage extensions, attachments, adaptors, joints or the like, which then extend similarly into or up to the boiler interior, can also be provided in the region of the outlet opening.

According to a further aspect of the present invention, a method for operating a device for the periodic cleaning of a boiler of a combustion system of the type described here according to the invention is proposed, wherein the device is connected in an automated manner by means of the at least one connection changer to various connecting units and by means of the at least one flow passage at least one of the following processes among a plurality of cleaning processes is carried out with a water jet:
cleaning with at least one solid body,
blowing out or drawing in of gases,
detecting an environmental parameter inside the boiler,
sealing the flow passage,
calibrating the orientation of the flow passage,
generating at least one image of the boiler interior.

In this respect, the use of the device according to the invention is especially also represented here in the case of a boiler of the previously described type. In this case, the cleaning processes are periodically carried out only when a corresponding degree of slagging in the inflow region of the device or of the cleaning device according to the invention is reached. Then, by selecting a suitable cleaning medium if necessary, a function of the fluid distributor can be realized via the different connecting units or the feed line. Even when a monitoring of the cleaning device and/or of the boiler is taking place, various functions can be realized separately and/or together with the device at predetermined, targeted points in time. The connection change in this case is carried out in an automated manner, i.e. especially fully automatically.

The individual processes in this case especially relate to the cleaning of the flow passage and/or of an internal region of the boiler with solid bodies which possibly via a carrier medium (for example a fluid) are moved through or shot through the flow passage. Furthermore, at predetermined points in time and predetermined positions or settings of the connection changer, gases can either be blown out or drawn in via the flow passage.

With regard to the detecting of an environmental parameter, it may additionally be noted that this can be necessary especially for the monitoring of the combustion processes, of the degree of slagging of the heat exchanger, of the cleaning of heat exchangers and of the controlling of these individual processes. For this purpose, for example sound generators, sound receivers, optical units (camera, pyrometer, laser, etc.), radiation conductors, sensors, pick-ups or similar elements can interact with the internal region of the boiler via the at least one flow passage and so determine the environmental parameters. A state variable inside the boiler is especially meant by environmental parameter, such as the boiler internal temperature, the flow velocity and/or temperature of the flue gas, the distance to an object inside the boiler, the degree of slagging of the heat exchangers, the reflection behavior of component parts and/or installed components of the boiler or similar. In particular, the environmental parameter also includes mean values, areal and/or spatial distributions of the parameter, the change behavior of the environmental parameter, or the like.

In case at least one flow passage is not (temporarily) used, or the penetration of combustion products is to be avoided, the flow passage can also be temporarily sealed via the connecting unit. For calibrating the orientation of the flow passage, a laser, which impinges upon a reference point on the opposite inner side of the boiler, can especially be emitted through the flow passage. In this way, it is ensured that even during thermal expansions of components of the boiler and/or of the device the desired aim for the fluid distributor is achieved. Furthermore, the at least one flow passage can also be used for generating an image of the boiler interior, that is to say for example a film, a picture, a thermal picture, or the like.

The invention and also the technical environment are explained in more detail in the figures. Reference is to be made to the fact the figures show especially preferred embodiment variants of the invention, to which this is not limited, however. Schematically in the drawing:

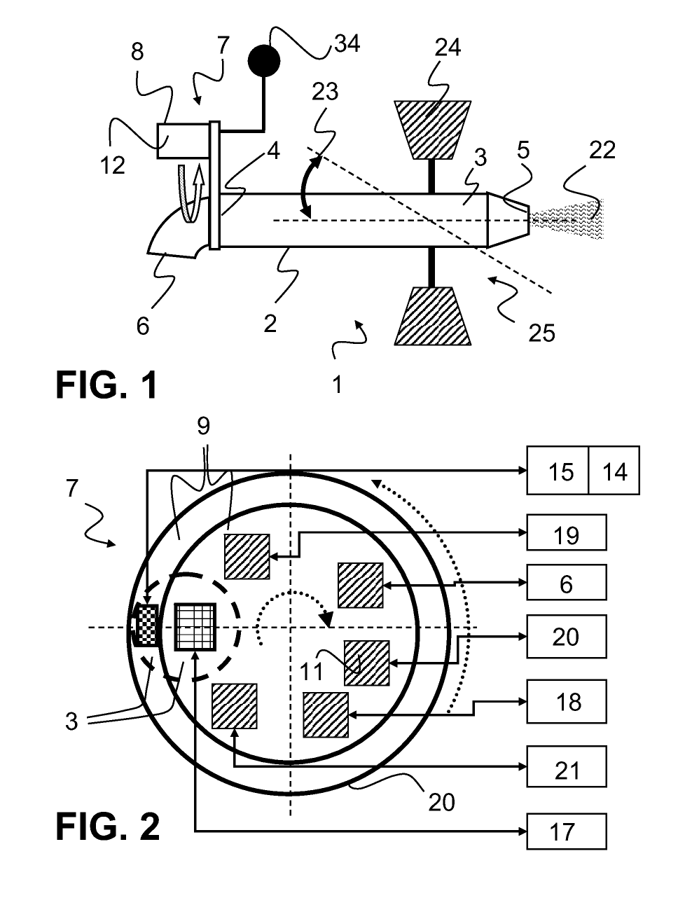

FIG. 1: shows a first embodiment variant of a device according to the invention,

FIG. 2: shows a detail of a further embodiment variant of the device according to the invention,

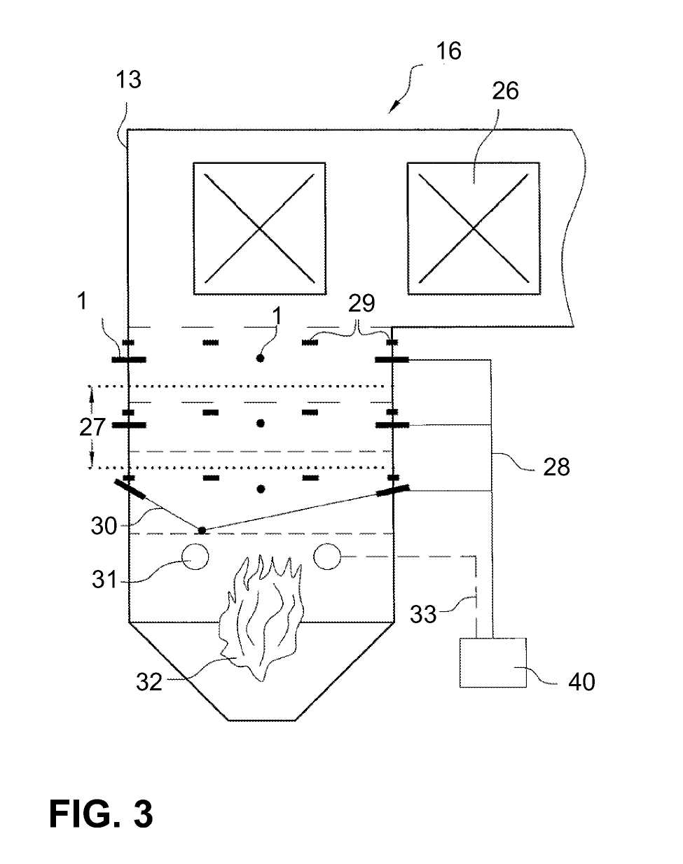

FIG. 3: shows an embodiment variant of a boiler of a combustion system with devices according to the invention, and

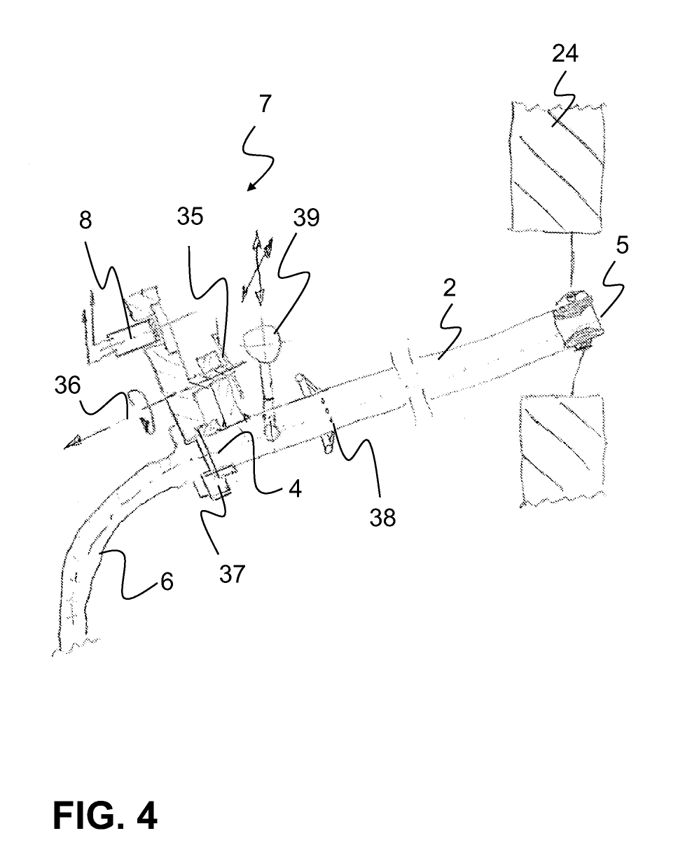

FIG. 4 shows a further embodiment variant of the device according to the invention.

FIG. 1 schematically shows an embodiment variant of a device 1 for cleaning a boiler,—which is not shown here, of a combustion system. The device 1 is arranged in all directions at an angle 23 in a hatch 25 of the boiler wall 24. In this case, the device 1 includes a fluid distributor 2 which extends through the hatch 25 into internal regions. Therefore, it is possible for the outlet opening 5 for the cleaning fluid 22 of the flow passage 30 to be positioned inside the boiler. The inlet opening 4 is provided on the side of the flow passage 3 opposite the outlet opening 5. Similarly, a connection changer 7 starts there, via which the feed line 6 for the cleaning fluid 22 is fastened here on the flow passage 3 in the illustrated position. In this case, the connection changer 7 is now designed so that it moves the feed line 6 away from the flow passage 3 (see schematic arrow), for example at a corresponding command of a control unit 34, and positions another connecting unit 8, for example a solid-body accelerator 12 in this case, in front of the inlet opening 4 of the flow passage 2. Therefore, the flow passage 3 can then be used for transporting or introducing solid bodies into the interior space of the boiler.

FIG. 2 schematically shows a detail of a further embodiment variant of the device 1 with a connection changer 7. In this, the flow passage 3 is seen in the direction of view towards the boiler with the connection changer 7 mounted in front. The connection changer 7 is constructed with two rotary disks 9 which, as illustrated by the dotted arrows, are rotatably positioned in relation to each other so that in each case they cover a correspondingly formed first flow passage and second flow passage 3. By rotating the rotary disks 9, it is possible to position different connections 11 in front of the desired flow passage 3 in each case. The fluid distributor 2 in this view is formed so that the smaller rotary disk 9 actually only covers a first flow passage 3 and therefore the partition between the first flow passage and the second flow passage coincides with the circumferential edge of the smaller rotary disk 9. Thus, the outer, larger rotary disk 9 can also be provided with corresponding connections which can be oriented towards the fluid distributor 2 regardless of the position of the inner, small rotary disk 9.

In this view, the larger rotary disk 9 is now provided with an individual connection 11 which enables a connection to a laser emitter 15 and to a radiation sensor 14. The inner, small rotary disk 9 on the other hand has six different connections 11 which are connected in each case to a connecting unit 8, which is illustrated by means of the double arrows. Thus, the connection changer 7 alternatively has connections 11 for a sealing unit 19, a cooling unit 20, a cleaning unit 18, a suction device 21 and an optical detection system 17. In this case, it is preferred that the connections 11 are distributed uniformly over the circumference 20 of the rotary disk 9, wherein penetrating of the adjacent rotary disk is especially also possible.

FIG. 3 is to schematically illustrate the use of the devices 1 according to the invention in a boiler 13 of a combustion system 16. At the bottom, the combustion chamber with the flame 32 is shown, wherein this flame is generated via possibly a plurality of burners 31. Above this combustion chamber, a plurality of level sections 27 are now provided which are constructed in each case with one or more devices 1 in the style of a cleaning device (especially a water lance blaster). A multiplicity of sensors 29 can additionally be provided in the individual level sections 27 in order to realize or monitor for example the degree of slagging in the boiler 13. A primary control unit 40 can then realize for example the cleaning process via the device 1, depending upon the degree of slagging, wherein corresponding control signals are communicated via the data connections 28. Similarly, information from the interior space of the boiler 13 to the control unit 40 can also be generated via the data connections 28, specifically especially when the devices 1 are operated with their additional function. Thus, for example the boiler 13 can be scanned or the position of the devices 1 determined by means of corresponding measuring beams 30. The control unit 40, for example on the basis of this information, controls the devices 1 (or also the connection changers 7), and the flame position across the burners 31 via control lines 33, etc. The flue gas which is generated by the flame 32 flows over not only the wall of the boiler 13 in this case, but also over heat exchangers 26 which are arranged therein or after it and which can also be cleaned with the devices 1 if necessary.

A further embodiment variant of the device is schematically illustrated in FIG. 4. Again, the fluid distributor 2 is shown, which is positioned with its outlet opening 5 in a corresponding hatch of the boiler wall 24. The fluid distributor 2 is connected via a joint 39 to the movement means (not shown here), which ultimately realizes the movement of the fluid distributor 2, especially in the style of a so-called water lance blaster of the type described in the introduction. Provision is made between the outlet opening 5 and the joint 39 for an additional barrier air feed 38 by which a gas can be directed into the internal regions of the fluid distributor 2 and can therefore be directed via the outlet opening 5 into the boiler so that penetration of dust is avoided.

In the region of the inlet opening 4, which in the embodiment variant which is shown is connected in this case via the coupling 37 of the connection changer 7 to the feed line 6, the connection changer 7 is preferably similarly fastened. The connection changer 7 in this case also includes a drive 35 which is fastened directly on the fluid distributor 2. This allows for example a rotation of the coupling 37 around the rotational axis 36 so that the additionally shown connecting unit 8 can be similarly positioned in front of the inlet opening 4. If necessary, provision can also be made here for sealing means for making contact with the fluid distributor 2. This development of the connection changer in the style of a “drum revolver” can be realized relatively compactly and with little mechanical expenditure.

### LIST OF DESIGNATIONS

1 Device
2 Fluid distributor
3 Flow passage
4 Inlet opening
5 Outlet opening
6 Feed line
7 Connection changer
8 Connecting unit
9 Rotary disk
10 Circumference
11 Connections
12 Solid-body accelerator
13 Boiler
14 Radiation sensor
15 Laser emitter
16 Combustion system
17 Optical detection system
18 Cleaning unit
19 Sealing unit
20 Cooling unit
21 Suction device
22 Cleaning fluid
23 Angle
24 Boiler wall
25 Hatch
26 Heat exchanger
27 Level section
28 Data connections
29 Sensor
30 Measuring beam
31 Burner
32 Flame
33 Control line
34 Control unit
35 Drive
36 Rotational axis
37 Coupling
38 Barrier air feed
39 Joint
40 Control unit

1. A device for cleaning a boiler of a combustion system, comprising:
a fluid distributor which has at least one flow passage with an inlet opening and an outlet opening,
wherein the inlet opening can be connected to a feed line for a fluid,
wherein the flow passage is constructed with at least one connection changer by which disconnecting of the at least one flow passage from the feed line and connecting of the at least one flow passage to at least one further connecting unit can be carried out.

2. The device as claimed in claim 1, wherein the at least one connection changer comprises a plurality of connecting units.

3. The device as claimed in claim 1, wherein the at least one connection changer comprises a rotary disk which has connections distributed over the circumference, which can be connected to the inlet opening.

4. The device as claimed in claim 1, wherein the at least one connecting unit comprises at least one of the following groups: solid-body accelerator, radiation sensor, laser emitter, optical detection system, cleaning unit, sealing unit, cooling unit, and suction device.

5. The device as claimed in claim 1, in which provision is made for a plurality of flow passages and the at least one connection changer can be connected to a plurality of flow passages at the same time.

6. A boiler of a combustion system with at least one device as claimed in claim 1, wherein the fluid distributor is movably arranged in a boiler wall so that the outlet opening is located inside the boiler and the at least one connection changer is located outside the boiler.

7. A method for operating a device for the periodic cleaning of a boiler of a combustion system, the device having a fluid distributor which has at least one flow passage with an inlet opening and an outlet opening, wherein the inlet opening can be connected to a feed line for a fluid, wherein the flow passage is constructed with at least one connection changer by which disconnecting of the at least one flow passage from the feed line and connecting of the at least one flow passage to at least one further connecting unit can be carried out, wherein the device is connected in an automated manner by means of the at least one connection changer to different connecting units and by means of the at least one flow passage at least one of the following processes among a plurality of cleaning processes is carried out with a water jet:
cleaning with at least one solid body,
blowing out or drawing in of gases,
detecting an environmental parameter inside the boiler,
sealing of the flow passage,
calibrating the orientation of the flow passage, and
generating at least one image of the boiler interior.
